(19) United States
(12) Patent Application Publication
(10) Pub. No.: US 2008/0019485 A1
(43) Pub. Date: Jan. 24, 2008

(54) Method for manufacturing a heat sink as well as heat sinks

(75) Inventors: Roland WEISS, Huttenberg (DE); Thorsten SCHEIBEL, Bad Nauheim (DE); Martin HENRICH, Wetzlar (DE); Marco EBERT, Wetter (DE); Andreas LAUER, Kirchhain (DE)

Correspondence Address: DENNISON, SCHULTZ & MACDONALD, 1727 KING STREET, SUITE 105, ALEXANDRIA, VA, 22314, US

(73) Assignee: SCHUNK KOHLENSTOFFTECHNIK GMBH, Heuchelheim (DE)

(21) Appl. No.: 11/679,571

(22) Filed: Feb. 27, 2007

(30) Foreign Application Priority Data
Mar. 2, 2006 (DE) 10 2006 010 232.0

(51) Int. Cl. H01J 35/10

(52) U.S. Cl. 378/199

(57) ABSTRACT

The invention relates to a method for manufacturing a highly heat-conductive heat sink from carbon material, in particular, a rotatable anode heat sink of an X-ray tube, comprising an anode body rotatable on a rotational axis with a focal ring that runs perpendicularly to the axis and is heat conductively connected to the heat sink. To achieve a higher degree of heat conductivity than that of prior art heat sinks, the invention proposes that for making a heat sink a mixture of carbon nanotubes and a binder is molded and subsequently heat-treated.

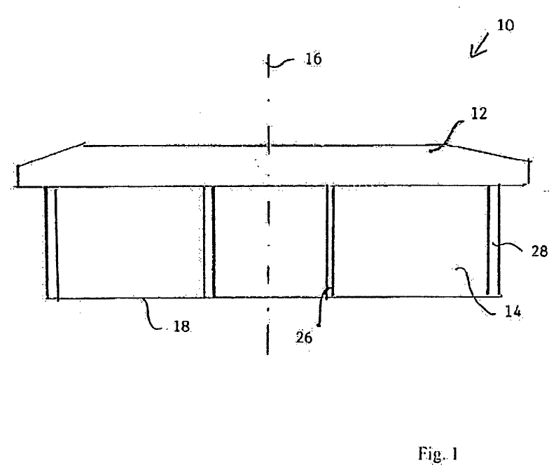

The invention relates to a method for manufacturing a highly heat conductive heat sink from carbon material, in particular, a rotatable anode heat sink of an X-ray tube, comprising an anode body rotatable on a rotational axis with a focal ring that runs perpendicularly to the axis and is heat conductively connected to the heat sink. The invention also relates to a highly heat-conductive heat sink made of carbon material, in particular, a rotatable anode heat sink of an X-ray anode, comprising an anode body rotatable on a rotational axis with a focal ring that runs perpendicularly to the axis and is heat-conductively connected to the heat sink.

A rotatable anode with a heat sink is disclosed in DE-B-103 04 936. To effectively conduct the high temperatures appearing on the focal ring, in this case the target surface, the heat sink features a goblet-shaped geometry that allows the highly heat conductive carbon fibers running inside the heat sink to end bluntly at both the underside of the target and at a cooling tube running coaxially to the rotational axis and through which a coolant is passed.

U.S. Pat. No. 5,943,389 concerns a rotatable anode in which a C-composite body provides a heat conducting connection, where parallel-running carbon fibers are connected via a carbon matrix. The heat conductivity of the carbon fibers can range from 400 W/mK-1,000 W/mK.

A prepregs rotatable anode with carbon fibers is described in JP-A-61-022546.

A heat sink particularly designed for electronic components such as printed circuits or semiconductor wafers is disclosed in WO-A-2005/028549. The heat sink features a composite body with nanotubes, where the base material is metal.

Fiber-reinforced composites have proven themselves in dissipating heat in rotatable anodes, because they are lighter than the metal bodies conventionally used, thereby allowing the rotatable anodes to rotate at higher frequency and be of greater diameter. In practice, however, it has been shown that the heat conductivity does not satisfy the requirements of highly advanced X-ray tubes, in particular those of CT-equipment. This results in overheating that demands frequent interruption of operation. There is also the disadvantage that construction is complex and expensive, since rotatable anodes made of carbon composites contain a cooling tube through which coolant is pumped.

The object of the present invention is a method for manufacturing a heat sink and further developing it to achieve a higher level of heat conductivity than that of heat sinks of the prior art, so that better heat dissipation is yielded. The heat sink should also be simple to manufacture and, in particular, must not require special cooling canals through which a cooling fluid is channeled.

According to the invention, the problem can essentially be solved through a process for making the heat sink in which a mixture of carbon fiber nanotubes and a binder is molded and subsequently subjected to heat treatment.

Deviating from the prior art, carbon nanotubes—also known as nanofibers—are mixed with a binder to then render a molded body by means of isostatic, semi-isostatic or axial pressing, for example. The molded body is then subsequently subjected to heat treatment.

The heat treatment can comprise hardening, pyrolysis or carbonization and graphitization. A resin-injection-process (resin transfer molding (RTM)) can also be used. One-time or repeated redensification can be performed using CVI (chemical vapor infiltration).

All processes applied in the manufacturing of C/C-molds can be used.

If isostatic pressing is used, applied pressure should be between 1000 and 2000 bar, preferably around 2000 bar. The same applies to manufacturing by means of semi-isostatic pressing. If axial pressing is performed, pressure should be between 500 and 700 bar, preferably around 700 bar.

The invention provides a heat sink, in particular a rotatable anode heat sink that is organic. The heat sink is realized as a ceramic body containing carbon fiber nanotubes that provide a high degree of heat dissipation.

As nanotubes, single and/or multi-walled tubes with and/or without open ends and/or with and/or without hollow spaces can be used. However, it is provided in particular that nanotubes with diameters between 10 and 150 nm, thus multi-walled nanotubes, are used. The length of the corresponding fibers can be up to 50 μm, without, however, the invention being restricted to this length.

In particular, a mixture of appropriate nanotubes with a resin is manufactured, where the carbon nanotubes account for between 20 and 70 vol. %, preferably between 50 and 65 vol. %, of the of the total volume. A filler, such as highly conductive graphite or resin, can be added to this mixture. Carbon nanotubes with a diameter greater than <1.0 nm, in particular <2.5 nm, can also be added to the mixture in the desired proportion.

Using nanotubes results in a molded body of greater heat conductivity, where heat conductivity is 600 W/mK or greater.

Multi-walled nanotubes measuring between 100 and 150 nm in diameter, so-called vapor grown carbon fibers, are preferably used to avoid an extremely high surface, which is the case with nanotubes of lesser diameter. The higher the surface of the nanotubes is, the greater the risk that the surfaces will be plated with materials that do not have such good conductivity, resulting in an undesired decrease in the heat conductivity of the molded body.

With regard to the heat treatment, it should be mentioned that for redensification, a gas phase impregnation is performed in the CVI-process with pyrolytic carbon (PyC). Other suitable impregnation means are also an option as long as they transform into carbon.

Heat treatment steps such as carbonization and graphitization should be performed at temperature ranges between 700 and 1200° C. and 2400 and 3500° C., respectively, where carbonization is preferably performed between 900 and 1150° C. and graphitization between 2600° C. and 3300° C.

To give the molded body adequate stability, a further embodiment provides that the heat treated heat sink is reinforced internally and/or externally following any required post-processing. A bearing ring, particularly one of carbon fiber reinforced carbon (CFC) can be used as reinforcement.

A heat sink of the type initially described is distinguished by the fact that the heat sink is made of or contains a molded body containing carbon fiber nanotubes. The carbon fiber nanotubes in particular are single or multi-walled with and/or open ends and/or with and/or without hollow space. The volume portion V of the nanotubes in the molded body runs between 20 and 70 vol. %, in particular between 50 vol. % and 65 vol. %.

Furthermore, the molded body can contain a heat-conducting filler such as graphite or resin.

The nanotubes preferably have an average diameter between 100 nm and 150 nm and do not feature hollow space. To increase heat conductivity, nanotubes of lesser diameter can be added.

Independent of this, the diameter of the nanotubes present in the molded body can range up to 500 nanometers without straying from the invention.

A bimodal mixture of nanotubes, namely a mixture of first and second nanotubes, is also possible, where the first nanotubes have an average diameter that clearly differs from that of the second nanotubes.

Furthermore, the invention also provides that the molded body is designed as a ring disc that can be bordered internally and/or externally by a bearing ring made of carbon fiber material.

Other geometries can also be considered without limiting the scope of the invention thereto.

The molded body can be manufactured by means of isostatic, semi-isostatic or axial pressing. It is also possible to design the molded body as an injection molded piece.

However, the molded body can also be manufactured through the mechanical processing of a green molded blank or as carbon material.

A green molded blank can be manufactured as follows. A compounded mixture of carbon nanotubes, binder and fillers is densified close to the final shape through a hot-pressing process at a temperature of approximately 150° C. at approximately 700 bar in a heatable die.

The axial pressing can also be performed in a die preheated to approximately 150° C., where holding time is preferably about 30 minutes. The mixture itself is introduced into the die once the die has reached the desired temperature.

When an axial pressing process is used to manufacture a green product, there is the option of introducing the compounded mixture into a cold die and then performing a densification under a defined temperature/pressure/time cycle to manufacture the green part.

When isostatic pressing is used, a cold isostatic process is selected, where ring-shaped rotatable anode heat sinks are manufactured preferably in the shape of a cylindrical tube (semi-isostatic) to minimize processing complexity. The semi-isostatic pressed body is then subjected to a temperature/time cycle until final hardening.

The term carbon material is understood as follows. The compound with carbon nanotubes possesses a consistency comparable to that of powder and can therefore be pressed, hardened, carbonized and graphitized in a manner analogous to the standard manufacturing processes used for carbon materials so that a carbon material is produced. The manufacturing technology allows various geometries that can subsequently be worked into a rotatable anode.

Additional details, advantages and features of the invention are found not only in the claims and the features that can be drawn from them—on their own and/or in combination—but also in the following description of an embodiment illustrated in the drawing.

Schematically illustrated in the only figure is a rotatable anode 10 particularly intended for a CT-machine. In the embodiment, the rotatable anode 10 is composed of a focal ring 12 and a heat sink 14. The focal ring 12 can be made of tungsten for example. The rotatable anode 10 is mounted on a shaft (not shown) and can be rotated around an axis 16.

To achieve a high density of measurement points in a short period of time, the rotatable anode 10 can be rotated according to use at frequencies of 150 Hz and higher, such as 400 Hz. The diameter can be between 150 and 250 mm, but is not limited to this range.

To facilitate good heat dissipation from the focal ring 12, thereby ensuring that the rotatable anode 10 can be used without any interruption for a long period of time, the heat sink 14 is made of a mixture of carbon nanotubes and a resin. Serving as carbon nanotubes are vapor grown carbon fibers that have a diameter between 100 and 150 nm and do not possess a hollow space. The carbon nanotubes account for between 20 to 70 vol. %, preferably 50 to 65 vol. % of the volume of the rotatable anode. To increase heat conductivity, nanotubes of lesser diameter, in particular single walled examples, can be added to the starting mixture for manufacturing the rotatable anode 10. Highly heat-conductive additives such as resin or carbon black can also be mixed in.

A corresponding heat sink 14 has a heat conductivity greater than 600 W/mk, thereby facilitating good heat dissipation from the focal ring 12. For sufficient stability, the heat sink 14 can feature a high-strength CFC bearing ring 26 internally, thus on the side of the rotational axis. A corresponding bearing ring 28 pressed onto the heat sink 14 can also be provided externally. Other types of fastening are also possible.

### EMBODIMENT 1

To manufacture a corresponding heat sink 14, a mixture of nanotubes and binder in the form of a thermoset is made. Resin, such as phenol resin, is preferably used as binder. Other polymers, including thermoplastics are also an option. The portion of carbon nanotubes should range from 50 to 65 vol. %. A molded body with a finished form close to the rotatable anode 10 can be manufactured from the resulting mixture either through injection molding or through isostatic, semi-isostatic or axial pressing. This molded body is carbonized and graphitized analogously to C/C manufacturing. Impregnation with carbon or a material transforming to carbon through carbonization is then performed. The impregnated form is then heat treated, where a one-time or multiple redensification of the heat-treated molded body can be performed. Redensification can be realized by means of CVI. Pressure densification is also an option.

The heat treatment includes the steps of carbonization and graphitization, where carbonization occurs between 700 and 1200° C., in particular between 900 and 1150° C., and graphitization occurs between 2400 and 3500° C., in particular between 2600 and 3300° C. (the process sequence can include a one-time or repeated redensification).

The molded body is then worked into the finished form, specifically through a cutting process. Finally, a bearing structure in the form of the internal and/or external CFC-rings 26, 28 can be applied to the worked body.

### EMBODIMENT 2

To manufacture a heat sink, a compound of carbon nanotubes or vapor grown carbon fibers with phenol resin as binder are introduced into a die preheated to 150° C., for example, and axially pressed under 700 bar pressing pressure for approximately 30 minutes to a ring with an external diameter of 205 mm and an internal diameter of 138 mm with a height of 70 mm. The molded article is then removed from the die and, following the removal of the surface skin, carbonized and graphitized before then being subjected to a triple impregnation/recarbonization cycle. This is then followed by finishing graphitization at temperatures in excess of 2800° C. and a subsequent finishing process. Following the finishing process, the heat sink is coated with PyC by means of CVD to prevent particle release during use. The heat sink can be outfitted with a CFC supporting ring should the desired rotational speed of the X-ray rotatable anode require it. The fastening to the rotating table and applying the focal ring are achieved using known technology, in particular soldering processes.

The invention provides a ceramic body heat sink, the starting base of which is an organic base with a mixture of carbon nanotubes and binder.

1. Method for manufacturing a highly heat-conductive heat sink from carbon material, in particular, a rotatable anode heat sink of an X-ray tube, comprising an anode body rotatably disposed on a rotational axis with a focal ring that runs horizontally as well as perpendicularly to the axis and is heat conductively connected to the heat sink, characterized by the fact that to make the heat sink a mixture of carbon fiber nanotubes and a binder is molded and subsequently subjected to heat treatment.

2. Method as claimed in claim 1, characterized by the fact that single and/or multi-walled tubes with and/or without open ends and/or with and/or without hollow spaces can be used as nanotubes.

3. Method as claimed in claim 1, characterized by the fact that the volume portion V of the nanotubes in the molded body is 20 vol. %≦V≦70 vol. %, in particular 50 vol. %≦V≦65 vol. %.

4. Method as claimed in claim 1, characterized by the fact that highly heat-conductive additives such as resin or carbon black can also be added to the mixture.

5. Method as claimed in claim 4, characterized by the fact that the volume portion VF of the heat conducting filler is 0 vol. %≦VF≦40 vol. %, in particular 0 vol. %≦VF≦10 vol. %.

6. Method as claimed in claim 1, characterized by the fact that for molding the mixture, isostatic, semi-isostatic or axial pressing is employed.

7. Method as claimed in claim 1, characterized by the fact that the heat sink is molded through injection molding.

8. Method as claimed in claim 1, characterized by the fact that the molded mixture is hardened and subjected to pyrolysis and graphitization.

9. Method as claimed in claim 1, characterized by the fact that the molded mixture is subjected to one-time or repeated redensification in particular in the CVI-process.

10. Method as claimed in claim 1, characterized by the fact that nanotubes with a diameter D of essentially 100 nm≦D≦150 nm are used.

11. Method as claimed in claim 1, characterized by the fact that vapor grown carbon fibers are used as nanotubes.

12. Method as claimed in claim 1, characterized by the fact that with nanotubes with a diameter D of D≦500 nm are used.

13. Method as claimed in claim 1, characterized by the fact that the mixture is a bimodal mixture of nanotubes of clearly different diameters.

14. Method as claimed in claim 1, characterized by the fact that carbon nanotubes with a length L of essentially L≦150 μm are used.

15. Method as claimed in claim 1, characterized by the fact that the heat sink molded from the mixture and subjected to heat treatment is reinforced internally and/or externally following any necessary post-processing.

16. Method as claimed in claim 15, characterized by the fact that bearing ring, particularly one of carbon fiber reinforced carbon (CFC) can be used as reinforcement.

17. Highly heat-conductive heat sink (14) made of carbon material, in particular, a rotatable anode heat sink of an X-ray tube, comprising an anode body (10) rotatably disposed on a rotational axis (16) with a focal ring (12) that runs horizontally as well as perpendicularly to the axis and is heat conductively connected to the heat sink, characterized by the fact that the heat sink (14) is an organic ceramic molded body that is made of or contains carbon nanotubes.

18. Heat sink as claimed in claim 17, characterized by the fact that the carbon nanotubes are bonded in a carbon matrix, where the volume portion of the carbon nanotubes is 20 vol. %≦V≦70 vol. %, in particular 50 vol. %≦V≦65 vol.%.

19. Heat sink as claimed in claim 17, characterized by the fact that the carbon nanotubes have a diameter D of essentially 100 nm≦D≦150 nm.

20. Heat sink as claimed in claim 17, characterized by the fact that the carbon nanotubes are vapor grown carbon fibers.

21. Heat sink as claimed in claim 17, characterized by the fact that the carbon nanotubes essentially have a length L of L≦150 μm.

22. Heat sink as claimed in claim 17, characterized by the fact that the heat sink (14) features a bearing ring (26, 28) both externally and internally.

23. Heat sink as claimed in claim 17, characterized by the fact that the bearing ring (26, 28) is made of carbon fiber reinforced carbon (CFC).
